(19) United States
(12) Patent Application Publication
(10) Pub. No.: US 2024/0385932 A1
(43) Pub. Date: Nov. 21, 2024

(54) SNAPSHOT INDEXING FOR HYBRID TWO-LEVEL SNAPSHOT INDIRECTION

(71) Applicant: Microsoft Technology Licensing, LLC, Redmond, WA (US)

(72) Inventor: Garret BUBAN, Snoqualmie, WA (US)

(21) Appl. No.: 18/319,166

(22) Filed: May 17, 2023

(51) Int. Cl. G06F 11/14; G06F 16/23; G06F 16/27

(52) U.S. Cl. CPC G06F 11/1458; G06F 16/2365; G06F 16/27; G06F 2201/84

(57) ABSTRACT

System, methods, apparatuses, and computer program products are disclosed for indexing snapshots for hybrid two-level snapshot indirection. A first snapshot is stored for a dataset. The first snapshot includes a plurality of pointers that each point to a corresponding first data block associated with the dataset. Data blocks created after a latest existing snapshot and data blocks of the dataset are modified after the latest existing snapshot are stored as second data blocks. Second pointers that each point to a corresponding second data block are generated. A current record maintains the second pointers pointing to the second data blocks, and references the first snapshot for first data blocks unmodified since storing the first snapshot.

### BACKGROUND

Snapshot indirection is a technique used in computer systems to create a consistent, point-in-time copy (a snapshot) of a dataset. In snapshot indirection, a new snapshot is created by first creating a pointer or reference (also known as an indirection) to the original data, rather than making a complete copy of the data. When a new snapshot is created, it appears to contain a complete copy of the original data, but it actually just points to the original data at the time of the snapshot. The use of snapshot indirection allows for more efficient use of storage space, as multiple snapshots can be created without needing to make multiple complete copies of the data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

System, methods, apparatuses, and computer program products are disclosed for indexing snapshots for hybrid two-level snapshot indirection. A first snapshot is stored for a dataset. The first snapshot includes a plurality of pointers that each point to a corresponding first data block associated with the dataset. Data blocks created after a latest existing snapshot and data blocks of the dataset are modified after the latest existing snapshot are stored as second data blocks. Second pointers that each point to a corresponding second data block are generated. A current record maintains the second pointers pointing to the second data blocks, and references the first snapshot for first data blocks unmodified since storing the first snapshot.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system that indexes snapshots for hybrid two-level indirection, in accordance with an embodiment.

FIG. 2 shows a block diagram of an example system that indexes snapshots for hybrid two-level indirection, in accordance with an embodiment.

FIG. 3 depicts a block diagram of exemplary snapshots employing hybrid two-level indirection, in accordance with an embodiment.

FIG. 4 depicts a flowchart of an example method for snapshot indexing for hybrid two-level indirection, in accordance with an embodiment.

FIG. 5 depicts a flowchart of an example method for creating a new snapshot, in accordance with an embodiment.

FIG. 6 depicts a block diagram of exemplary snapshots during snapshot deletion, in accordance with an embodiment.

FIG. 7 depicts a flowchart of an example method for deleting a snapshot, in accordance with an embodiment.

FIG. 8 depicts a flowchart of an example method for handling references to a deleted snapshot, in accordance with an embodiment.

FIG. 9 depicts a flowchart of an example method for moving a data block, in accordance with an embodiment.

FIG. 10 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Snapshot indexing is a technique to improve the efficiency and speed of accessing data in point-in-time snapshots. In snapshot indexing, an index is created for each snapshot that maps the location of each data block in the snapshot to its corresponding location in the original data. When a snapshot is created, an index is also created that maps the location of each data block of the snapshot to its corresponding location in the original data. This allows for efficient retrieval of data from the snapshot, as the index can be used to locate the specific blocks of data that are needed. Snapshot indexing can be implemented in various ways, such as, but not limited to, using a hash table or a binary search tree. The choice of indexing method depends on the size and complexity of the data, as well as the performance requirements of the application.

One technique for snapshot indexing involves creating a list of snapshot indices that each only contain the data blocks unique to that snapshot version. This technique uses simple, one-level indices. The storage for the data can be easily manipulated since each block is only pointed to by one index in the list. However, reading a desired data block requires backwards traversal of the list of snapshot indices until the data block is found. If the list contains thousands of snapshots and the desired data block hasn't changed since the first snapshot, finding the data block will require traversal of thousands of snapshot indices.

Another technique to snapshot indexing involves having each snapshot point to all the blocks needed for that snapshot. This technique uses a more complex index that requires reference counting of the data blocks. Since each data block may have many indices pointing to it, storage for the data cannot be easily manipulated. However, this technique provides very fast data reads because each snapshot knows exactly where each data block is located.

A third technique for snapshot indexing involves the use of a second-level index for the data blocks. The second-level index points to the data blocks, and each snapshot points to an entry in this second-level index. With this technique, storage for the data can be easily manipulated because only the second-level index points to it, and reading a data block requires only two lookups-one in the snapshot and one in the second-level index. The main disadvantage with this technique is that the second-level index's growth is effectively unbounded. Since every data block has an entry in the second-level index, it can become difficult to manage as the amount of new data grows.

In embodiments disclosed herein, each snapshot of a dataset include pointers or references to all the data blocks of the dataset. In embodiments, data blocks unique to a snapshot are referenced by a direct pointer in the snapshot. For example, when a new snapshot is created it includes a direct pointer to any data block that is not referenced by another snapshot. In embodiments, data blocks not unique to a snapshot are referenced by referencing a previous snapshot. For example, when a new snapshot is created it includes, for any data block that is referenced by another snapshot, a reference to the snapshot that includes the direct pointer to the data block. Since each data block in the dataset is referenced only by one direct pointer, storage for the dataset can be easily manipulated. Furthermore, indirect references to a data block requires only two lookups-one to the snapshot version containing the direct pointer to the data block and one to the data block-thereby improving lookup performance. Lastly, each snapshot essentially acts as a second-level index for data blocks unique to that snapshot. As such, the size of second-level indices are limited to the number of data blocks unique to a particular snapshot.

These and further embodiments are disclosed herein that enable the functionality described above and further such functionality. Such embodiments are described in further detail as follows.

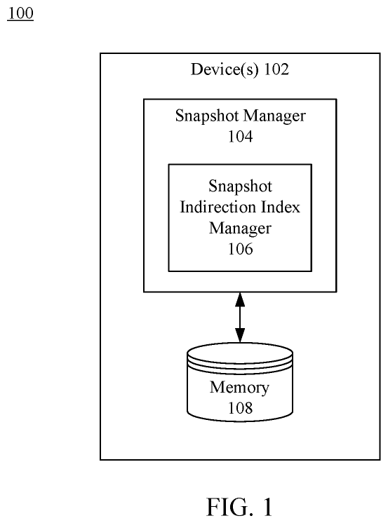

For instance, FIG. 1 shows a block diagram of an example system 100 for snapshot indexing with hybrid two-level indirection, in accordance with an embodiment. As shown in FIG. 1, system 100 may include one or more devices 102 that may include a snapshot manager 104 and a memory 108. Snapshot manager 104 may further include a snapshot indirection index manager 106.

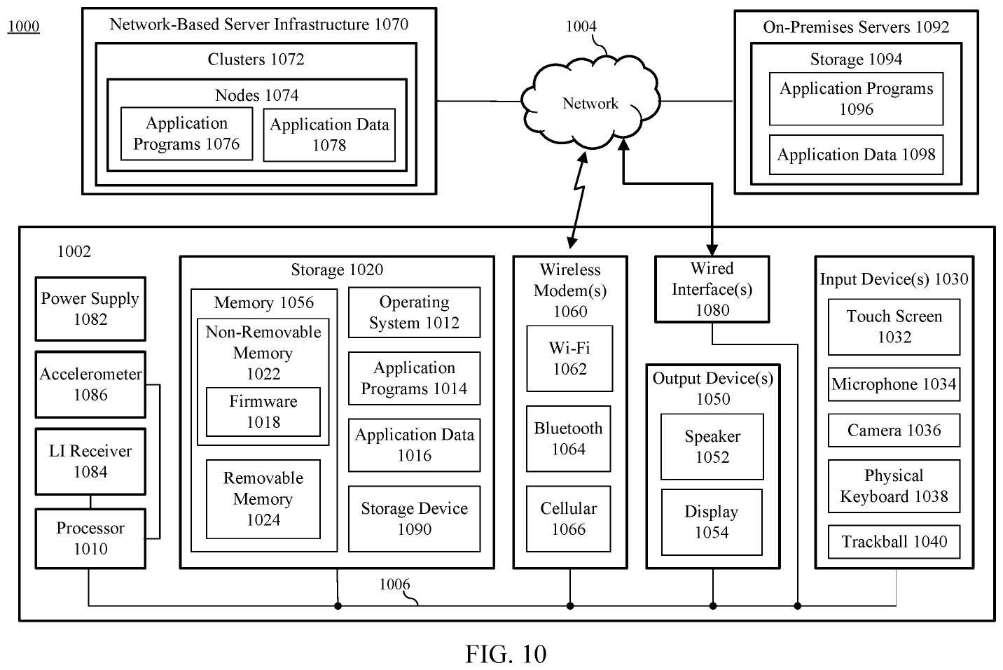

Devices(s) 102 may include any computing device suitable for performing functions ascribed thereto in the following description, as will be appreciated by persons skilled in the relevant art(s), including those mentioned elsewhere herein or otherwise known. Various example implementations of devices(s) 102 are described below in reference to FIG. 10 (e.g., computing device 1002, network-based server infrastructure 1070, and/or on-premises servers 1092).

Snapshot manager 104 may manage snapshots by facilitating reading and writing of data stored in memory 108. In embodiments, snapshot manager 104 may receive requests for point-in-time versions of data and employ snapshot indirection index manager 106 to locate and retrieve the requested data. In embodiments, snapshot manager 104 may receive write requests and employ snapshot indirection index manager 106 to write the date to memory 108 and maintain a record of the location where the data is stored.

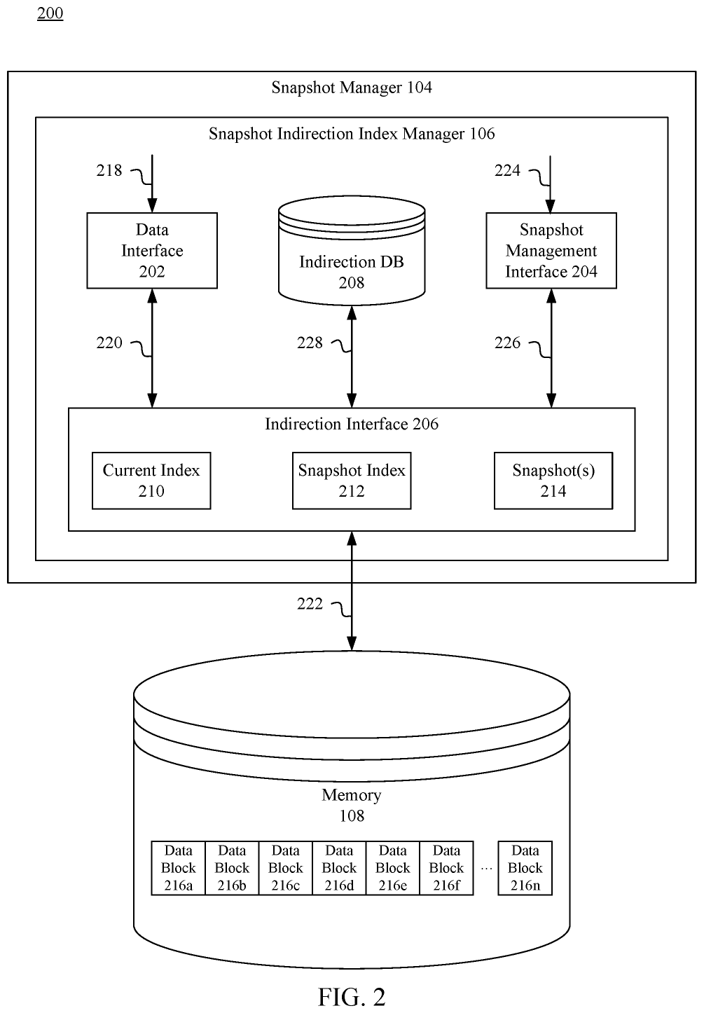

Snapshot indirection index manager 106 may manage a snapshot indirection index that facilitates the lookup and retrieval of data blocks stored in memory 108. In embodiments, snapshot indirection index manager 106 may maintain one or more snapshots of a dataset and a plurality one or more direct pointers to data blocks stored in memory 108. Snapshot indirection index manager 106 will be described in greater detail below in conjunction with FIG. 2.

Memory 108 may include any media suitable for performing functions ascribed thereto in the following description, as will be appreciated by persons skilled in the relevant art(s), including those mentioned elsewhere herein or otherwise known. Various example implementations of memory 108 are described below in reference to FIG. 10 (e.g., storage 1020, and/or storage 1094).

System 100 of FIG. 1 may be configured in various ways, in embodiments. For instance, in an embodiment, system 100 may perform snapshot indexing with hybrid two-level indirection, such as shown in FIG. 2. FIG. 2 shows a block diagram of an example system 200 that indexes snapshots for hybrid two-level indirection, in accordance with an embodiment. As shown in FIG. 2, system 200 includes snapshot manager 104, snapshot indirection index manager 106, and memory 108 of FIG. 1. In an embodiment of FIG. 2, snapshot indirection index manager 106 further includes a data interface 202, a snapshot management interface 204, an indirection interface 206, and an indirection database 208. Furthermore, in an embodiment of FIG. 2, memory 108 may include one or more data blocks 216a-216n. Additionally, in embodiments, indirection interface 206 may further include a current index 210, a snapshot index 212, and one or more snapshots 214.

Data interface 202 may receive data requests 218 and interact with indirection interface 206 to fulfill data requests 218. Data requests 218 may include, but are not limited to, read requests, write requests, delete requests, move requests, defragmentation requests, garbage collection requests, and/or any other types of requests to access and/or manipulate the data of memory 108. Data requests 218 may include an identification of the data requested, including, but not limited to, a logical block address (LBA), and a version of the data requested, including, but not limited to, temporal information, version identifier, and/or the like. In embodiments, data interface 202 may receive data requests 218 from a user and/or a program of device(s) 102. Furthermore, in embodiments, data interface 202 may provide responses to the requests, including any requested data, back to the user and/or program of device(s) 102.

Snapshot management interface 204 may receive snapshot management requests 224 and interact with indirection interface 206 to manage snapshot(s) 214. Snapshot management requests 224 may include, but are not limited to, requests to capture a snapshot, requests to schedule a snapshot capture event, requests to delete a snapshot, requests to prevent the deletion of a snapshot, requests to move and/or export a snapshot, and/or any other types of requests to access and/or manipulate snapshot(s) 214. In embodiments, may receive snapshot management requests 224 from a user and/or a program of device(s) 102. Furthermore, in embodiments, data interface 204 may provide responses to the requests, including any requested data, back to the user and/or program of device(s) 102.

Indirection interface 206 may generate and/or maintain a snapshot indirection index to allow for the retrieval of point-in-time data associated with snapshot(s) 214 and/or current data that is not part of any snapshot. In embodiments, indirection interface 206 maintains current index 210 comprising one or more direct pointers to each data block created and/or modified after the chronologically latest existing (i.e., non-deleted) snapshot was captured, and one or more references to snapshot(s) 214 for any data block that has not been modified since the latest existing snapshot was captured.

Indirection interface 206 may also generate and/or maintain snapshot index 212 that includes a list of snapshot(s) 214. In embodiments, snapshot index 212 may allow indirection interface 206 to determine whether a snapshot has been deleted, determine the chronologically succeeding and/or preceding snapshot, determine metadata associated with a snapshot, including, but not limited to, capture time, size, expected deletion date, and/or the like. In embodiments, snapshot index 212 may be implemented using a data structure different from a list, including, but not limited to, an array, a queue, a tree, a stack, and/or the like.

Indirection interface 206 may also maintain one or more of snapshot(s) 214. As discussed above, each snapshot 214 includes direct pointers to data blocks unique to the snapshot and references to a previous snapshot for data blocks not unique to the snapshot.

In embodiments, indirection interface 206 may receive communications 220 from data interface 202. In embodiments, communications 220 may include data requests 218. In embodiments, indirection interface 206 may process read requests by referring to one or more of current index 210, snapshot index 212, and/or snapshot(s) 214 to locate and/or retrieve one or more data block(s) 216 to fulfill the request by providing the requested data as communications 220 to data interface 202.

Prior to the creation of any snapshot, indirection interface 206 may, in embodiments, process data requests 218 creating new data by storing the new data in an unused data block 216 and associating, in current index 210, the new data with a direct pointer to data block 216 storing the new data. Prior to the creation of any snapshot, indirection interface 206 may, in embodiments, process data requests 218 modifying existing data by following a pointer in current index 210 associated with the modified data and overwriting the data block 216 storing the modified data. For illustrative purposes, an exemplary current index 210 is shown below in TABLE 1. In this example of current index 210, data has been written to LBA0 and LBA2 and current index 210 associates LBA0 and LBA2 with direct pointers to data block 216a and data block 216b, respectively.

TABLE 1

| Logical Block Address (LBA) | Data location |
|---|---|
| LBA0 | [pointer to data block 216a] |
| LBA1 | [NULL] |
| LBA2 | [pointer to data block 216b] |
| LBA3 | [NULL] |

In embodiments, indirection interface 206 may receive communications 226 from snapshot management interface 204. In embodiments, communications 226 may include snapshot management requests 224. In embodiments, indirection interface 206 may process a snapshot management request 224 to capture a snapshot by storing and/or capturing current index 210 to snapshot(s) 214 as a new snapshot. In embodiments, indirection interface 206 may update current index 210 by replacing any direct pointers in current index 210 with references to the new snapshot. Lastly, in embodiments, indirection interface 206 may update snapshot index 212 with information related to the new snapshot. Continuing with the example above, TABLE 2 below illustrates the exemplary current index 210 shown in TABLE 1 above after the creation of a snapshot (e.g., snapshot #1). For example, the pointers in the exemplary current index 210 shown in TABLE 1 are updated to refer to snapshot #1 in TABLE 2.

TABLE 2

| Logical Block Address (LBA) | Data location |
|---|---|
| LBA0 | [reference to snapshot #1] |
| LBA1 | [NULL] |
| LBA2 | [reference to snapshot #1] |
| LBA3 | [NULL] |

After the creation of a snapshot, data requests 218 modifying data that is referenced in current index 210 by a direct pointer are processed by indirection interface 206 in the same manner as described above. In particular, indirection interface 206 may modify the data by following the direct pointer in current index 210 associated with the modified data and overwriting the data block 216 storing the modified data. However, data requests 218 that modify data that is referenced in current index 210 by a reference to a snapshot may be processed differently by indirection interface 206. For example, indirection interface 206 may store the modified data in an unused data block 216 and associate, in current index 210, the modified data with a direct pointer to data block 216 storing the modified data. In embodiments, indirection interface 206 leaves the original data untouched. Continuing with the example above, TABLE 3 below illustrates the exemplary current index 210 shown in TABLE 2 above after the modification of data associated with LBA0. For example, indirection interface 206 updates the reference for LBA0 with a pointer to the data block storing the modified data (e.g., data block 216c).

TABLE 3

| Logical Block Address (LBA) | Data location |
|---|---|
| LBA0 | [pointer to data block 216c] |
| LBA1 | [NULL] |
| LBA2 | [reference to snapshot #1] |
| LBA3 | [NULL] |

In embodiments, indirection interface 206 may process a snapshot management request 224 to delete a snapshot. For instance, indirection interface 206 may select the chronologically oldest available snapshot captured after the to-be-deleted snapshot as a candidate snapshot. In embodiments, indirection interface 206 may analyze candidate snapshot to determine whether it contains any references to a corresponding direct pointer in the to-be-deleted snapshot. For each reference in the candidate snapshot to the to-be-deleted snapshot, indirection interface 206 may replace the reference in the candidate snapshot with a direct pointer to the data block 216 in memory 108 pointed to by the corresponding pointer in the to-be-deleted snapshot. After replacing all the references in the candidate snapshot with direct pointers to data blocks 216 in memory 108, indirection interface 206 may delete the to-be-deleted snapshot from snapshot(s) 214 and update snapshot index 212 to reflect the deletion of the to-be-deleted snapshot.

In embodiments, the deletion of a snapshot only results in the replacement of references in the candidate snapshot (i.e., the chronologically oldest available snapshot captured after the deleted snapshot). This simplifies snapshot deletion operations because it only requires one pointer to be updated for each affected data block 216 in memory 108. However, in embodiments, snapshots captured after the candidate snapshot may contain references to a deleted snapshot. In embodiments, indirection interface 206 resolves references to a deleted snapshot by referencing snapshot index 212 to identify the chronologically oldest available snapshot captured after the deleted snapshot. In embodiments, indirection interface 206 may refer to the identified snapshot to retrieve the desired data block 216 from memory 108.

In embodiments, the to-be-deleted snapshot may be the newest available snapshot. In such a scenario, the to-be-deleted snapshot may contain the only direct pointers to the current version of data. In embodiments, indirection interface 206 may instead analyze current index 210 to determine whether it contains any references to a corresponding direct pointer in the to-be-deleted snapshot. For each reference in the current index to the to-be-deleted snapshot, indirection interface 206 may replace the reference in current index 210 with a direct pointer to the data block 216 in memory 108 pointed to by the corresponding pointer in the particular snapshot. Updating current index 210 allows indirection interface 206 to maintain direct pointer(s) to the data block(s) 216 associated with the current version of the data after deleting the newest available snapshot.

In embodiments, the deletion of a snapshot may result in a data block 216 in memory 108 that is not referenced by any pointer. In embodiments, indirection interface 206 mark such unreferenced data blocks 216 for garbage collection.

In embodiments, indirection interface 206 may also receive data requests 218 to move data from one data block 216 in memory 108 to a destination data block 216 in memory 108. For example, such data requests 218 may include, but are not limited to, data move requests, memory defragmentation requests, and the like. In embodiments, indirection interface 206 may update the direct pointer associated with each moved data block 216 to point to the destination data block 216. In embodiments where the moved data block is not part of any of snapshot(s) 214, indirection interface 206 may update the direct pointer in current index 210. In embodiments where the moved data block is part of a snapshot 214, indirection interface may update the snapshot 214 that contains the direct pointer to the moved data block.

Indirection database 208 may include any media suitable for performing functions ascribed thereto in the following description, as will be appreciated by persons skilled in the relevant art(s), including those mentioned elsewhere herein or otherwise known. Various example implementations of indirection database 208 are described below in reference to FIG. 10 (e.g., storage 1020, and/or storage 1094). In embodiments, indirection database 208 may store one or more of current index 210, snapshot index 212, and/or one or more of snapshot(s) 214. For instance, indirection interface 206 may employ indirection database 208 to persist portions or all of current index 210, snapshot index 212, and/or snapshot(s) 214 that exceed the working memory available to indirection interface 206. Furthermore, indirection interface 206 may employ indirection database 208 to recreate or rebuild portions or all of current index 210, snapshot index 212, and/or snapshot(s) 214 after a restart due to, for example, but not limited to, a power failure, a system failure, scheduled maintenance, and the like.

Data block(s) 216a-216n in memory 108 may include discrete units of data of a particular or variable size. By breaking data down into smaller, manageable units, data blocks can help improve the speed and accuracy of data processing and analysis. In snapshot indirection, modifications to data results in the creation of a copy of the data, thus allowing for point-in-time versions of the data. The use of data blocks in snapshot indirection limits the copying of data to data blocks containing modified data, thereby reducing the amount of data that needs to be copied. While FIG. 2 depicts only 7 data block(s) 216, in embodiments, memory 108 may contain more or less data blocks 216. Furthermore, data block(s) 216 may be stored in memory 108 in a different order and/or arrangement that what is depicted in FIG. 2.

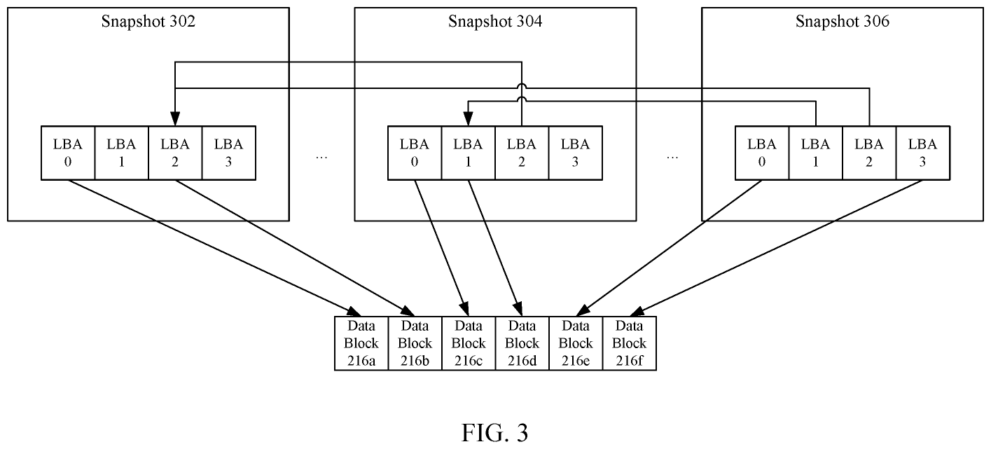

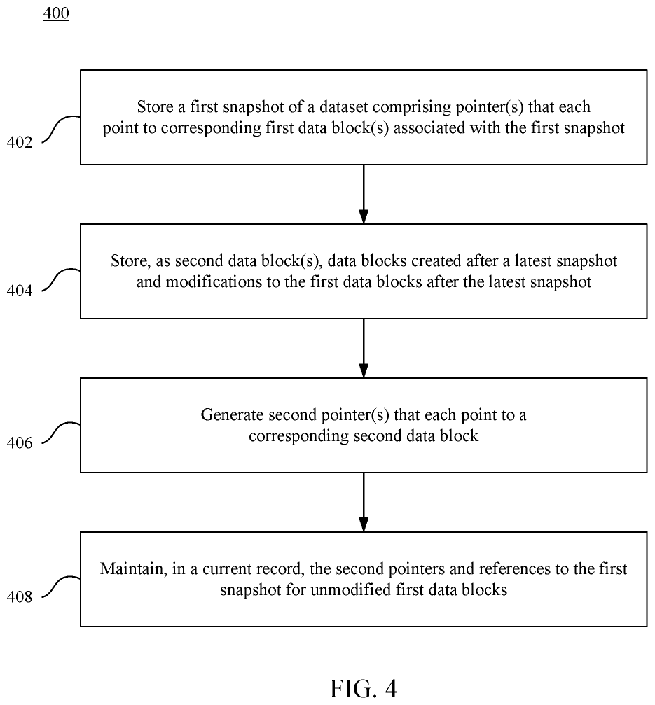

Embodiments described herein may operate in various ways to perform snapshot indirection indexing. For example, FIG. 3 depicts a block diagram of exemplary snapshots employing hybrid two-level indirection, in accordance with an embodiment. As shown in FIG. 3, snapshots 302, 304, and 306 may include one or more pointers to data blocks 216a-216f and/or one or more references to another snapshot. In embodiments, snapshots 302-306 are examples of snapshot(s) 214 of FIG. 2, and blocks 216a-216f are examples of data block(s) 216 of FIG. 2. In FIG. 3, snapshots 302, 304, and 306 are captured in chronological order, from oldest to newest, respectively. For simplicity, other snapshots (not depicted) may have been captured before, after, or in between any of snapshots 302, 304, and/or 306. Furthermore, snapshots 302, 304, and/or 306 may include fewer or more LBAs than depicted in FIG. 3. Additionally, more, or less data block(s) 216 than is depicted in FIG. 3. In FIG. 3, Snapshot 302 includes direct pointers for LBA0 and LBA2 pointing to data blocks 216a and 216b, respectively. In FIG. 3, snapshot 304 contains direct pointers for LBA0 and LBA1 pointing to data blocks 216c and 216d, respectively. Snapshot 304 further includes, for LBA2, a reference to snapshot 302. In FIG. 3, snapshot 306 contains direct pointers for LBA0 and LBA3 pointing to data blocks 216e and 216f, respectively. Snapshot 306 further includes, for LBA1 and LBA2, references to snapshots 302 and 304, respectively. FIG. 3 is provided for illustrative purposes only, and will be referred to below in conjunction with FIGS. 4-8.

Embodiments described herein may operate in various ways to perform snapshot indirection indexing. For example, FIG. 4 depicts a flowchart 400 of an example method for snapshot indexing for hybrid two-level indirection, in accordance with an embodiment. Device(s) 102 of FIG. 1, and/or snapshot manager 104, snapshot indirection index manager 106, and/or memory 108 of FIGS. 1 and 2, and/or data interface 202, snapshot management interface 204, indirection interface 206, indirection database 208, current index 210, snapshot index 212, and/or snapshot(s) 214 of FIG. 2 may operate according to flowchart 400, for example. Note that not all steps of flowchart 400 may need to be performed in all embodiments, and in some embodiments, the steps of flowchart 400 may be performed in different orders than shown. Flowchart 400 is described as follows with respect to FIGS. 1-3 for illustrative purposes.

Flowchart 400 starts at step 402. In step 402, a first snapshot is stored, the first snapshot comprising pointer(s) that each point to corresponding first data block(s) associated with the first snapshot. For example, indirection interface 206 may store snapshot 302 in snapshot(s) 214. As shown in FIG. 3, snapshot 302 may include, for LBA0 and LBA2, direct pointers to data blocks 216a and 216b, respectively.

In step 404, data blocks created after a latest existing snapshot and modifications to the first data blocks after the latest existing snapshot are stored as second data block(s). For example, indirection interface 206 may store, in unused data block(s) 216 in memory 108, any data blocks created after the latest existing snapshot and any first data blocks modified after the latest existing snapshot.

In step 406, second pointer(s) that each point to a corresponding second data block are created. For example, indirection interface 206 may generate a second pointer for each second data block.

In step 408, the second pointers and references to the first snapshot for unmodified first data blocks are maintained in a current record. For example, indirection interface 206 may maintain, in current index 210, the generated second pointers in association with the corresponding second data blocks, and references to the first snapshot for unmodified first data blocks.

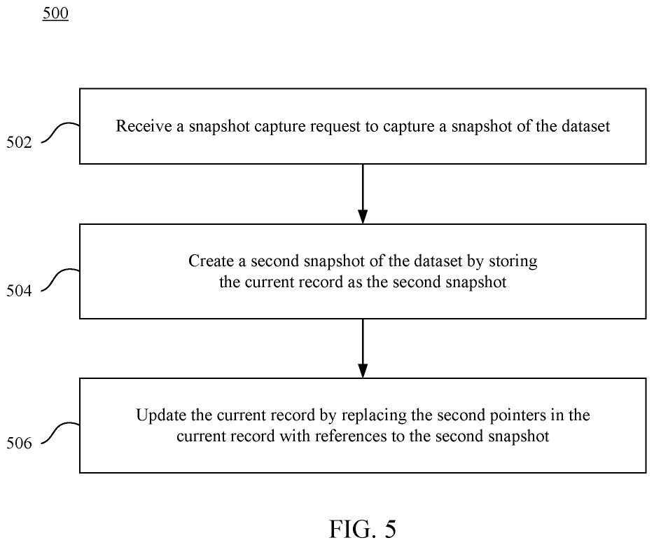

Embodiments described herein may operate in various ways to perform snapshot creation. For example, FIG. 5 depicts a flowchart 500 of an example method for creating a new snapshot, in accordance with an embodiment. Device(s) 102 of FIG. 1, and/or snapshot manager 104, snapshot indirection index manager 106, and/or memory 108 of FIGS. 1 and 2, and/or data interface 202, snapshot management interface 204, indirection interface 206, indirection database 208, current index 210, snapshot index 212, and/or snapshot(s) 214 of FIG. 2 may operate according to flowchart 500, for example. Note that not all steps of flowchart 500 may need to be performed in all embodiments, and in some embodiments, the steps of flowchart 500 may be performed in different orders than shown. Flowchart 500 is described as follows with respect to FIGS. 1-3 for illustrative purposes.

Flowchart 500 starts at step 502. In step 502, a snapshot capture request is received to capture a snapshot of the dataset. For example, snapshot management interface 204 and/or indirection interface 206 may receive a snapshot management request 224 to capture a snapshot.

In step 504, a second snapshot is created by storing the current record as the second snapshot. For example, indirection interface 206 may create a second snapshot 306 by storing current record 212 in snapshot(s) 214 as a new snapshot. In embodiments, indirection interface 206 may update snapshot index 212 to reflect the creation of second snapshot 306.

In step 506, the current record is updated by replacing the second pointers in the current record with references to the second snapshot. For example, indirection interface 206 may update current record 210 by replacing direct pointers in current record 210 with references to second snapshot 306.

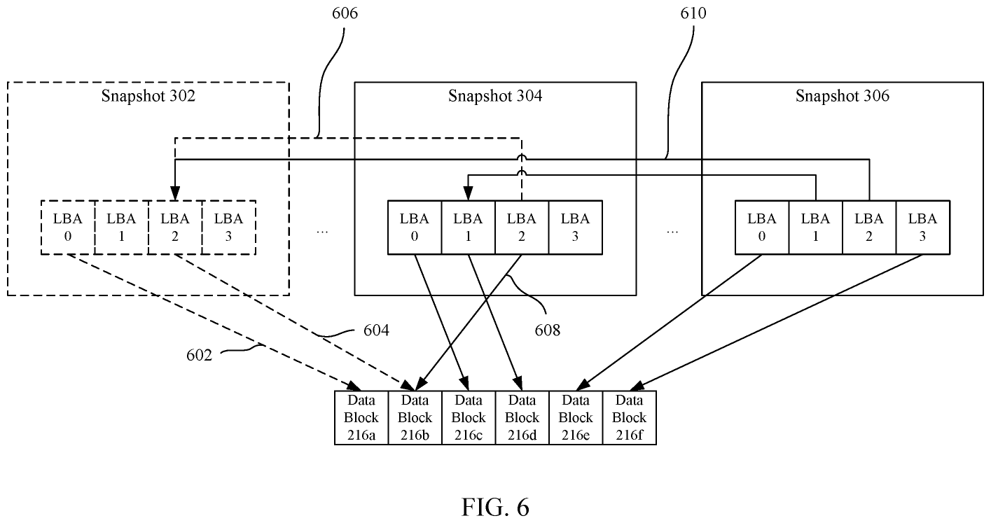

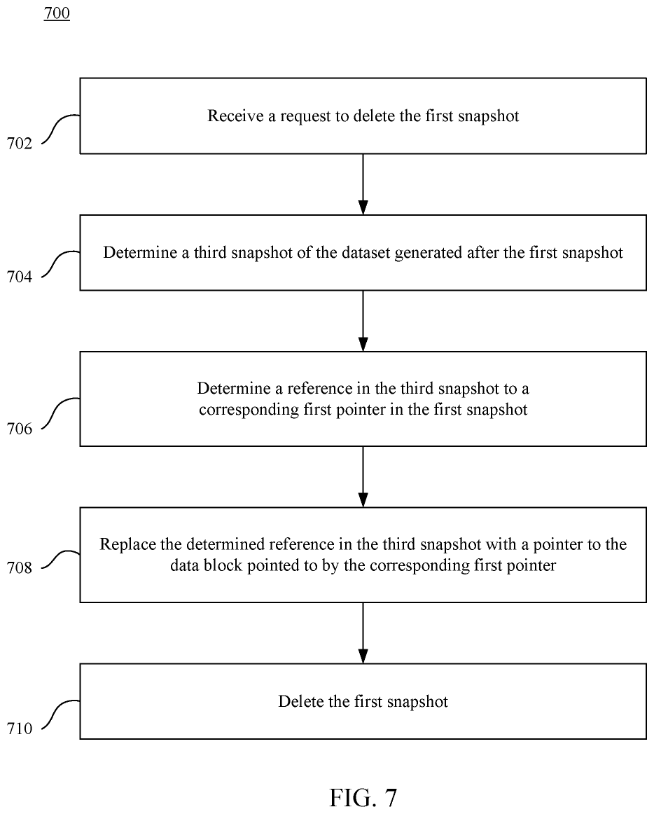

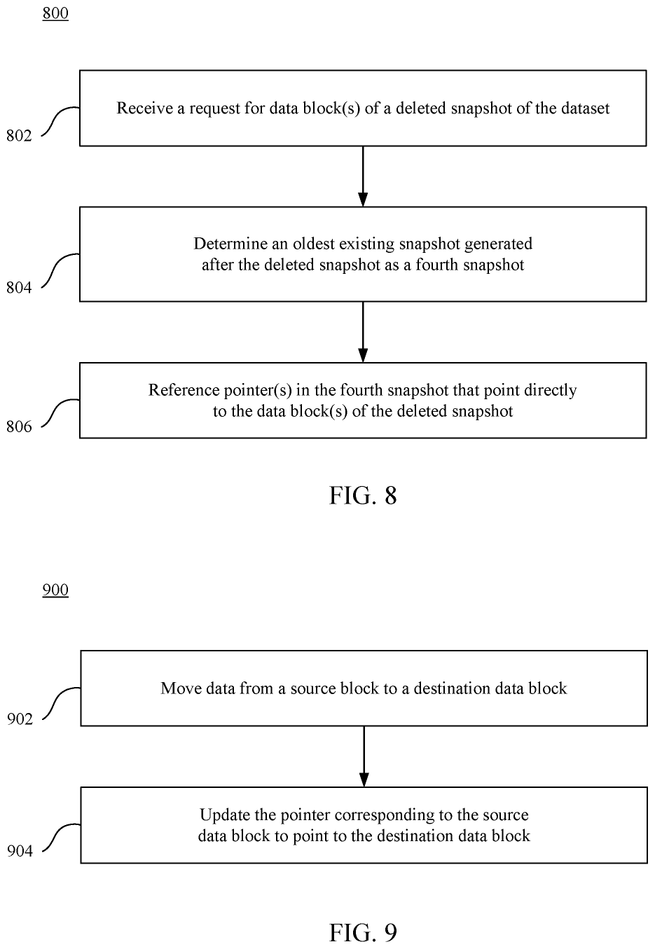

Embodiments described herein may operate in various ways to perform snapshot deletion. For example, FIG. 6 depicts a block diagram of exemplary snapshots during snapshot deletion, in accordance with an embodiment. In embodiments, FIG. 6 depicts the snapshots of FIG. 3 after snapshot 302 has been deleted. Elements of FIG. 6 depicted in dashed lines have been deleted as part of the deletion of snapshot 302. As shown in FIG. 6, snapshot 302, direct pointers 602 and 604, and reference 606 have been deleted as part of the deletion of snapshot 302. As shown in FIG. 6, reference 606 in snapshot 304 has been replaced with a direct pointer 608 to data block 216b. FIG. 6 is provided for illustrative purposes only, and will be referred to below in conjunction with FIGS. 7 and 8.

Embodiments described herein may operate in various ways to perform snapshot deletion. For example, FIG. 7 depicts a flowchart of an example method for deleting a snapshot, in accordance with an embodiment. Device(s) 102 of FIG. 1, and/or snapshot manager 104, snapshot indirection index manager 106, and/or memory 108 of FIGS. 1 and 2, and/or data interface 202, snapshot management interface 204, indirection interface 206, indirection database 208, current index 210, snapshot index 212, and/or snapshot(s) 214 of FIG. 2 may operate according to flowchart 700, for example. Note that not all steps of flowchart 700 may need to be performed in all embodiments, and in some embodiments, the steps of flowchart 500 may be performed in different orders than shown. Flowchart 700 is described as follows with respect to FIGS. 1-3 and 6 for illustrative purposes.

Flowchart 700 starts at step 702. In step 702, a request is received to delete the first snapshot. For example, snapshot management interface 204 and/or indirection interface 206 may receive a snapshot management request 224 to delete snapshot 302.

In step 704, a third snapshot of the dataset is determined, the third snapshot generated after the first snapshot. For example, indirection interface 206 may determine snapshot 304 as a snapshot of the dataset captured after snapshot 302.

In step 706, a reference in the third snapshot is determined to reference a corresponding first pointer in the first snapshot. For example, indirection interface 206 may determine that snapshot 304 includes a reference 606 to a first pointer 604 in snapshot 302.

In step 708, the determined reference in the third snapshot is replaced with a pointer to the data block pointed to by the corresponding first pointer. For example, indirection interface 206 may replace reference 606 in snapshot 304 with a direct pointer 608 to data block 216b.

In step 710, the first snapshot is deleted. For example, indirection interface 206 may delete snapshot 302 from snapshot(s) 214. In embodiments, indirection interface 206 may update snapshot index 212 to reflect the deletion of snapshot 302.

Embodiments described herein may operate in various ways to resolve references to delete snapshots. For example, FIG. 8 depicts a flowchart of an example method for handling references to a deleted snapshot, in accordance with an embodiment. Device(s) 102 of FIG. 1, and/or snapshot manager 104, snapshot indirection index manager 106, and/or memory 108 of FIGS. 1 and 2, and/or data interface 202, snapshot management interface 204, indirection interface 206, indirection database 208, current index 210, snapshot index 212, and/or snapshot(s) 214 of FIG. 2 may operate according to flowchart 800, for example. Note that not all steps of flowchart 800 may need to be performed in all embodiments, and in some embodiments, the steps of flowchart 800 may be performed in different orders than shown. Flowchart 800 is described as follows with respect to FIGS. 1-3 and 6 for illustrative purposes.

Flowchart 800 starts at step 802. In step 802, a request is received for data block(s) of a deleted snapshot of the dataset. For example, indirection interface 206 may encounter a reference 610 for a data block in deleted snapshot 302 during the fulfillment of data requests 218 for data blocks associated with snapshot 306.

In step 804, an oldest existing snapshot generated after the deleted snapshot is determined as a fourth snapshot. For example, indirection interface 206 may determine snapshot 304 as the oldest existing snapshot(s) 214 generated after deleted snapshot 302. In embodiments, indirection interface 206 may identify the oldest existing snapshot 304 by referencing snapshot index 212.

In step 806, pointer(s) in the fourth snapshot that point directly to the data block(s) of the delete snapshot are referenced. For example, indirection interface 206 may reference direct pointer 608 in snapshot 304 to access data block 216b in memory 108.

Embodiments described herein may operate in various ways to move data blocks. For example, FIG. 9 depicts a flowchart of an example method for moving a data block, in accordance with an embodiment. Device(s) 102 of FIG. 1, and/or snapshot manager 104, snapshot indirection index manager 106, and/or memory 108 of FIGS. 1 and 2, and/or data interface 202, snapshot management interface 204, indirection interface 206, indirection database 208, current index 210, snapshot index 212, and/or snapshot(s) 214 of FIG. 2 may operate according to flowchart 900, for example. Flowchart 900 is described as follows with respect to FIGS. 1 and 2 for illustrative purposes.

Flowchart 900 starts at step 902. In step 902, data is moved from a source data block to a destination data block. For example, indirection interface 206 may move data from a source data block (e.g., data block 216c in memory 108) to a destination data block (e.g., data block 216a in memory 108). In embodiments, indirection interface 206 may move the data during fulfillment of data requests 218, such as, but not limited to, data move requests, memory defragmentation requests, and the like.

In step 904, the pointer corresponding to the source data block is updated to point to the destination data block. For example, indirection interface 206 may update the direct pointer associated with the source data block (e.g., data block 216c in memory 108) to point to the destination data block (e.g., data block 216a in memory 108). In embodiments where the moved data block is not part of any of snapshot(s) 214, indirection interface 206 may update the direct pointer in current index 210. In embodiments where the moved data block is part of a snapshot 214, indirection interface may update the snapshot 214 that contains the direct pointer to the moved data block.

### III. Example Mobile Device and Computer System Implementation

The systems and methods described above in reference to FIGS. 1-9, including device(s) 102, snapshot manager 104, snapshot indirection index manager 106, memory 108, data interface 202, snapshot management interface 204, indirection interface 206, indirection database 208, current index 210, snapshot index 212, snapshot(s) 214, data block(s) 216a-216n, and/or each of the components described therein, and the steps of flowcharts 400, 500, 700, 800, and/or 900 may be implemented in hardware, or hardware combined with one or both of software and/or firmware. For example, device(s) 102, snapshot manager 104, snapshot indirection index manager 106, memory 108, data interface 202, snapshot management interface 204, indirection interface 206, indirection database 208, current index 210, snapshot index 212, snapshot(s) 214, data block(s) 216a-216n, and/or each of the components described therein, and the steps of flowcharts 400, 500, 700, 800, and/or 900 may be each implemented as computer program code/instructions configured to be executed in one or more processors and stored in a computer readable storage medium. Alternatively, device(s) 102, snapshot manager 104, snapshot indirection index manager 106, memory 108, data interface 202, snapshot management interface 204, indirection interface 206, indirection database 208, current index 210, snapshot index 212. snapshot(s) 214, data block(s) 216a-216n, and/or each of the components described therein, and steps of flowcharts 400, 500, 700, 800, and/or 900 may be each implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices, such as system 100 of FIG. 1, in which embodiments may be implemented are described as follows with respect to FIG. 10. FIG. 10 shows a block diagram of an exemplary computing environment 1000 that includes a computing device 1002. In some embodiments, computing device 1002 is communicatively coupled with devices (not shown in FIG. 10) external to computing environment 1000 via network 1004. Network 1004 comprises one or more networks such as local area networks (LANs), wide area networks (WANs), enterprise networks, the Internet, etc., and may include one or more wired and/or wireless portions. Network 1004 may additionally or alternatively include a cellular network for cellular communications. Computing device 1002 is described in detail as follows

Computing device 1002 can be any of a variety of types of computing devices. For example, computing device 1002 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 1002 may alternatively be a stationary computing device such as a desktop computer, a personal computer (PC), a stationary server device, a minicomputer, a mainframe, a supercomputer, etc.

As shown in FIG. 10, computing device 1002 includes a variety of hardware and software components, including a processor 1010, a storage 1020, one or more input devices 1030, one or more output devices 1050, one or more wireless modems 1060, one or more wired interfaces 1080, a power supply 1082, a location information (LI) receiver 1084, and an accelerometer 1086. Storage 1020 includes memory 1056, which includes non-removable memory 1022 and removable memory 1024, and a storage device 1090. Storage 1020 also stores an operating system 1012, application programs 1014, and application data 1016. Wireless modem(s) 1060 include a Wi-Fi modem 1062, a Bluetooth modem 1064, and a cellular modem 1066. Output device(s) 1050 includes a speaker 1052 and a display 1054. Input device(s) 1030 includes a touch screen 1032, a microphone 1034, a camera 1036, a physical keyboard 1038, and a trackball 1040. Not all components of computing device 1002 shown in FIG. 10 are present in all embodiments, additional components not shown may be present, and any combination of the components may be present in a particular embodiment. These components of computing device 1002 are described as follows.

A single processor 1010 (e.g., central processing unit (CPU), microcontroller, a microprocessor, signal processor, ASIC (application specific integrated circuit), and/or other physical hardware processor circuit) or multiple processors 1010 may be present in computing device 1002 for performing such tasks as program execution, signal coding, data processing, input/output processing, power control, and/or other functions. Processor 1010 may be a single-core or multi-core processor, and each processor core may be single-threaded or multithreaded (to provide multiple threads of execution concurrently). Processor 1010 is configured to execute program code stored in a computer readable medium, such as program code of operating system 1012 and application programs 1014 stored in storage 1020. Operating system 1012 controls the allocation and usage of the components of computing device 1002 and provides support for one or more application programs 1014 (also referred to as “applications” or “apps”). Application programs 1014 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1002 can communicate with any other component according to function, although not all connections are shown for case of illustration. For instance, as shown in FIG. 10, bus 1006 is a multiple signal line communication medium (e.g., conductive traces in silicon, metal traces along a motherboard, wires, etc.) that may be present to communicatively couple processor 1010 to various other components of computing device 1002, although in other embodiments, an alternative bus, further buses, and/or one or more individual signal lines may be present to communicatively couple components. Bus 1006 represents one or more of any of several types of bus structures, including a memory bus or memory controller, a peripheral bus, an accelerated graphics port, and a processor or local bus using any of a variety of bus architectures.

Storage 1020 is physical storage that includes one or both of memory 1056 and storage device 1090, which store operating system 1012, application programs 1014, and application data 1016 according to any distribution. Non-removable memory 1022 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1022 may include main memory and may be separate from or fabricated in a same integrated circuit as processor 1010. As shown in FIG. 10, non-removable memory 1022 stores firmware 1018, which may be present to provide low-level control of hardware. Examples of firmware 1018 include BIOS (Basic Input/Output System, such as on personal computers) and boot firmware (e.g., on smart phones). Removable memory 1024 may be inserted into a receptacle of or otherwise coupled to computing device 1002 and can be removed by a user from computing device 1002. Removable memory 1024 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1090 may be present that are internal and/or external to a housing of computing device 1002 and may or may not be removable. Examples of storage device 1090 include a hard disk drive, a SSD, a thumb drive (e.g., a USB (Universal Serial Bus) flash drive), or other physical storage device.

One or more programs may be stored in storage 1020. Such programs include operating system 1012, one or more application programs 1014, and other program modules and program data. Examples of such application programs may include, for example, device(s) 102, snapshot manager 104, snapshot indirection index manager 106, memory 108, data interface 202, snapshot management interface 204, indirection interface 206, indirection database 208, current index 210, snapshot index 212, snapshot(s) 214, data block(s) 216a-216n, and/or each of the components described therein, along with any components and/or subcomponents thereof, as well as the flowcharts/flow diagrams (e.g., flowcharts 400, 500, 700, 800, and/or 900) described herein, including portions thereof, and/or further examples described herein.

Storage 1020 also stores data used and/or generated by operating system 1012 and application programs 1014 as application data 1016. Examples of application data 1016 include web pages, text, images, tables, sound files, video data, and other data, which may also be sent to and/or received from one or more network servers or other devices via one or more wired or wireless networks. Storage 1020 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1002 through one or more input devices 1030 and may receive information from computing device 1002 through one or more output devices 1050. Input device(s) 1030 may include one or more of touch screen 1032, microphone 1034, camera 1036, physical keyboard 1038 and/or trackball 1040 and output device(s) 1050 may include one or more of speaker 1052 and display 1054. Each of input device(s) 1030 and output device(s) 1050 may be integral to computing device 1002 (e.g., built into a housing of computing device 1002) or external to computing device 1002 (e.g., communicatively coupled wired or wirelessly to computing device 1002 via wired interface(s) 1080 and/or wireless modem(s) 1060). Further input devices 1030 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1054 may display information, as well as operating as touch screen 1032 by receiving user commands and/or other information (e.g., by touch, finger gestures, virtual keyboard, etc.) as a user interface. Any number of each type of input device(s) 1030 and output device(s) 1050 may be present, including multiple microphones 1034, multiple cameras 1036, multiple speakers 1052, and/or multiple displays 1054.

One or more wireless modems 1060 can be coupled to antenna(s) (not shown) of computing device 1002 and can support hybrid two-way communications between processor 1010 and devices external to computing device 1002 through network 1004, as would be understood to persons skilled in the relevant art(s). Wireless modem 1060 is shown generically and can include a cellular modem 1066 for communicating with one or more cellular networks, such as a GSM network for data and voice communications within a single cellular network, between cellular networks, or between the mobile device and a public switched telephone network (PSTN). Wireless modem 1060 may also or alternatively include other radio-based modem types, such as a Bluetooth modem 1064 (also referred to as a “Bluetooth device”) and/or Wi-Fi 1062 modem (also referred to as an “wireless adaptor”). Wi-Fi modem 1062 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1064 is configured to communicate with another Bluetooth-capable device according to the Bluetooth short-range wireless technology standard(s) such as IEEE 802.15.1 and/or managed by the Bluetooth Special Interest Group (SIG).

Computing device 1002 can further include power supply 1082, LI receiver 1084. accelerometer 1086, and/or one or more wired interfaces 1080. Example wired interfaces 1080 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 1080 of computing device 1002 provide for wired connections between computing device 1002 and network 1004, or between computing device 1002 and one or more devices/peripherals when such devices/peripherals are external to computing device 1002 (e.g., a pointing device, display 1054, speaker 1052, camera 1036, physical keyboard 1038, etc.). Power supply 1082 is configured to supply power to each of the components of computing device 1002 and may receive power from a battery internal to computing device 1002, and/or from a power cord plugged into a power port of computing device 1002 (e.g., a USB port, an A/C power port). LI receiver 1084 may be used for location determination of computing device 1002 and may include a satellite navigation receiver such as a Global Positioning System (GPS) receiver or may include other type of location determiner configured to determine location of computing device 1002 based on received information (e.g., using cell tower triangulation, etc.). Accelerometer 1086 may be present to determine an orientation of computing device 1002.

Note that the illustrated components of computing device 1002 are not required or all-inclusive, and fewer or greater numbers of components may be present as would be recognized by one skilled in the art. For example, computing device 1002 may also include one or more of a gyroscope, barometer, proximity sensor, ambient light sensor, digital compass, etc. Processor 1010 and memory 1056 may be co-located in a same semiconductor device package, such as being included together in an integrated circuit chip, FPGA, or system-on-chip (SOC), optionally along with further components of computing device 1002.

In embodiments, computing device 1002 is configured to implement any of the above-described features of flowcharts herein. Computer program logic for performing any of the operations, steps, and/or functions described herein may be stored in storage 1020 and executed by processor 1010.

In some embodiments, server infrastructure 1070 may be present in computing environment 1000 and may be communicatively coupled with computing device 1002 via network 1004. Server infrastructure 1070, when present, may be a network-accessible server set (e.g., a cloud-based environment or platform). As shown in FIG. 10, server infrastructure 1070 includes clusters 1072. Each of clusters 1072 may comprise a group of one or more compute nodes and/or a group of one or more storage nodes. For example, as shown in FIG. 10, cluster 1072 includes nodes 1074. Each of nodes 1074 are accessible via network 1004 (e.g., in a “cloud-based” embodiment) to build, deploy, and manage applications and services. Any of nodes 1074 may be a storage node that comprises a plurality of physical storage disks, SSDs, and/or other physical storage devices that are accessible via network 1004 and are configured to store data associated with the applications and services managed by nodes 1074. For example, as shown in FIG. 10, nodes 1074 may store application data 1078.

Each of nodes 1074 may, as a compute node, comprise one or more server computers, server systems, and/or computing devices. For instance, a node 1074 may include one or more of the components of computing device 1002 disclosed herein. Each of nodes 1074 may be configured to execute one or more software applications (or “applications”) and/or services and/or manage hardware resources (e.g., processors, memory, etc.), which may be utilized by users (e.g., customers) of the network-accessible server set. For example, as shown in FIG. 10, nodes 1074 may operate application programs 1076. In an implementation, a node of nodes 1074 may operate or comprise one or more virtual machines, with each virtual machine emulating a system architecture (e.g., an operating system), in an isolated manner, upon which applications such as application programs 1076 may be executed.

In an embodiment, one or more of clusters 1072 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1072 may be a datacenter in a distributed collection of datacenters. In embodiments, exemplary computing environment 1000 comprises part of a cloud-based platform such as Amazon Web Services® of Amazon Web Services, Inc. or Google Cloud Platform™ of Google LLC, although these are only examples and are not intended to be limiting.

In an embodiment, computing device 1002 may access application programs 1076 for execution in any manner, such as by a client application and/or a browser at computing device 1002. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 1002 may additionally and/or alternatively synchronize copies of application programs 1014 and/or application data 1016 to be stored at network-based server infrastructure 1070 as application programs 1076 and/or application data 1078. For instance, operating system 1012 and/or application programs 1014 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 1020 at network-based server infrastructure 1070.

In some embodiments, on-premises servers 1092 may be present in computing environment 1000 and may be communicatively coupled with computing device 1002 via network 1004. On-premises servers 1092, when present, are hosted within an organization's infrastructure and, in many cases, physically onsite of a facility of that organization. On-premises servers 1092 are controlled, administered, and maintained by IT (Information Technology) personnel of the organization or an IT partner to the organization. Application data 1098 may be shared by on-premises servers 1092 between computing devices of the organization, including computing device 1002 (when part of an organization) through a local network of the organization, and/or through further networks accessible to the organization (including the Internet). Furthermore, on-premises servers 1092 may serve applications such as application programs 1096 to the computing devices of the organization, including computing device 1002. Accordingly, on-premises servers 1092 may include storage 1094 (which includes one or more physical storage devices such as storage disks and/or SSDs) for storage of application programs 1096 and application data 1098 and may include one or more processors for execution of application programs 1096. Still further, computing device 1002 may be configured to synchronize copies of application programs 1014 and/or application data 1016 for backup storage at on-premises servers 1092 as application programs 1096 and/or application data 1098.

Embodiments described herein may be implemented in one or more of computing device 1002, network-based server infrastructure 1070, and on-premises servers 1092. For example, in some embodiments, computing device 1002 may be used to implement systems, clients, or devices, or components/subcomponents thereof, disclosed elsewhere herein. In other embodiments, a combination of computing device 1002, network-based server infrastructure 1070, and/or on-premises servers 1092 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1020. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1014) may be stored in storage 1020. Such computer programs may also be received via wired interface(s) 1080 and/or wireless modem(s) 1060 over network 1004. Such computer programs, when executed or loaded by an application, enable computing device 1002 to implement features of embodiments discussed herein. Accordingly, such computer programs represent controllers of the computing device 1002.

Embodiments are also directed to computer program products comprising computer code or instructions stored on any computer-readable medium or computer-readable storage medium. Such computer program products include the physical storage of storage 1020 as well as further physical storage types.

### VI. Additional Example Embodiments

In an embodiment, a method includes: storing a first snapshot of a dataset, the first snapshot comprising a plurality of first pointers that each point to a corresponding first data block of a plurality of first data blocks associated with the first snapshot; storing, as second data blocks, data blocks created after a latest existing snapshot and modifications to the first data blocks modified after the latest existing snapshot; generating a plurality of second pointers that each point to a corresponding second data block of the second data blocks; and maintaining, in a current record, the second pointers and references to the first snapshot for unmodified first data blocks.

In an embodiment, the method further includes: receiving a snapshot capture request to capture a snapshot of the dataset; creating a second snapshot of the dataset by storing the current record as the second snapshot; and updating the current record by replacing the second pointers in the current record with references to the second snapshot.

In an embodiment, the method further includes: receiving a read request for the second snapshot; reading second data blocks by following the second pointers; reading unmodified first data blocks by referencing the first snapshot; and returning the second data blocks and the unmodified first data blocks.

In an embodiment, referencing unmodified first data blocks by referencing the first snapshot includes: referencing first pointers in the first snapshot that point directly to the unmodified first data blocks.

In an embodiment, the method further includes: receiving a request to delete the first snapshot; determining a third snapshot of the dataset generated after the first snapshot; determining a reference in the third snapshot to a corresponding first pointer in the first snapshot; replacing the determined reference in the third snapshot with a pointer to the data block pointed to by the corresponding first pointer; and deleting the first snapshot.

In an embodiment, the method further includes: receiving a request for a data block of a deleted snapshot of the dataset; determining an oldest existing snapshot of the dataset generated after the deleted snapshot as a fourth snapshot; and referencing pointers in the fourth snapshot that point directly to the data block of the deleted snapshot.

In an embodiment, the method further includes: moving data from a source data block of the first data blocks to a destination data block; and updating the first pointer corresponding to the source data block to point to the destination data block.

In an embodiment, a system for snapshot indirection includes: a processor; and a memory device that stores program code structured to cause the processor to: store a first snapshot of a dataset, the first snapshot comprising a plurality of first pointers that each point to a corresponding first data block of a plurality of first data blocks associated with the first snapshot; store, as second data blocks, data blocks created after a latest existing snapshot and modifications to the first data blocks modified after the latest existing snapshot; generate a plurality of second pointers that each point to a corresponding second data block of the second data blocks; and maintain, in a current record, the second pointers and references to the first snapshot for unmodified first data blocks.

In an embodiment, the program code is further structured to cause the processor to: receive a snapshot capture request to capture a snapshot of the dataset; create a second snapshot of the dataset by storing the current record as the second snapshot; and update the current record by replacing the second pointers in the current record with references to the second snapshot.

In an embodiment, the program code is further structured to cause the processor to: receive a read request for the second snapshot; read second data blocks by following the second pointers; read unmodified first data blocks by referencing the first snapshot; and return the second data blocks and the unmodified first data blocks.

In an embodiment, to reference unmodified first data blocks by referencing the first snapshot, the program code is further structured to cause the processor to: reference first pointers in the first snapshot that point directly to the unmodified first data blocks.

In an embodiment, the program code is further structured to cause the processor to: receive a request to delete the first snapshot; determine a third snapshot of the dataset generated after the first snapshot; determine a reference in the third snapshot to a corresponding first pointer in the first snapshot; replace the determined reference in the third snapshot with a pointer to the data block pointed to by the corresponding first pointer; and delete the first snapshot.

In an embodiment, the program code is further structured to cause the processor to: receive a request for a data block of a deleted snapshot of the dataset; determine an oldest existing snapshot of the dataset generated after the deleted snapshot as a fourth snapshot; and reference pointers in the fourth snapshot that point directly to the data block of the deleted snapshot.

In an embodiment, the program code is further structured to cause the processor to: move data from a source data block of the first data blocks to a destination data block; and update the first pointer corresponding to the source data block to point to the destination data block.

In an embodiment, a computer-readable storage medium comprising computer-executable instructions, that when executed by a processor, cause the processor to: store a first snapshot of a dataset, the first snapshot comprising a plurality of first pointers that each point to a corresponding first data block of a plurality of first data blocks associated with the first snapshot; store, as second data blocks, data blocks created after a latest existing snapshot and modifications to the first data blocks modified after the latest existing snapshot; generate a plurality of second pointers that each point to a corresponding second data block of the second data blocks; and maintain, in a current record, the second pointers and references to the first snapshot for unmodified first data blocks.

In an embodiment, the computer-executable instructions, when executed by the processor, further cause the processor to: receive a snapshot capture request to capture a snapshot of the dataset; create a second snapshot of the dataset by storing the current record as the second snapshot; and update the current record by replacing the second pointers in the current record with references to the second snapshot.

In an embodiment, the computer-executable instructions, when executed by the processor, further cause the processor to: receive a read request for the second snapshot; read second data blocks by following the second pointers; read unmodified first data blocks by referencing the first snapshot; and return the second data blocks and the unmodified first data blocks.

In an embodiment, to reference unmodified first data blocks by referencing the first snapshot, the computer-executable instructions, when executed by the processor, further cause the processor to: reference first pointers in the first snapshot that point directly to the unmodified first data blocks.

In an embodiment, the computer-executable instructions, when executed by the processor, further cause the processor to: receive a request to delete the first snapshot; determine a third snapshot of the dataset generated after the first snapshot; determine a reference in the third snapshot to a corresponding first pointer in the first snapshot; replace the determined reference in the third snapshot with a pointer to the data block pointed to by the corresponding first pointer; and delete the first snapshot.

In an embodiment, the computer-executable instructions, when executed by the processor, further cause the processor to: receive a request for a data block of a deleted snapshot of the dataset; determine an oldest existing snapshot of the dataset generated after the deleted snapshot as a fourth snapshot; and reference pointers in the fourth snapshot that point directly to the unmodified first data blocks.

### VII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed:

1. A method comprising:
storing a first snapshot of a dataset, the first snapshot comprising a plurality of first pointers that each point to a corresponding first data block of a plurality of first data blocks associated with the first snapshot;
storing, as second data blocks, data blocks created after a latest existing snapshot and modifications to the first data blocks modified after the latest existing snapshot;
generating a plurality of second pointers that each point to a corresponding second data block of the second data blocks; and
maintaining, in a current record, the second pointers and references to the first snapshot for unmodified first data blocks.

2. The method of claim 1, further comprising:
receiving a snapshot capture request to capture a snapshot of the dataset;
creating a second snapshot of the dataset by storing the current record as the second snapshot; and
updating the current record by replacing the second pointers in the current record with references to the second snapshot.

3. The method of claim 2, further comprising:
receiving a read request for the second snapshot;
reading second data blocks by following the second pointers;
reading unmodified first data blocks by referencing the first snapshot; and
returning the second data blocks and the unmodified first data blocks.

4. The method of claim 1, wherein said referencing unmodified first data blocks by referencing the first snapshot comprises:
referencing first pointers in the first snapshot that point directly to the unmodified first data blocks.

5. The method of claim 1, further comprising:
receiving a request to delete the first snapshot;
determining a third snapshot of the dataset generated after the first snapshot;
determining a reference in the third snapshot to a corresponding first pointer in the first snapshot;
replacing the determined reference in the third snapshot with a pointer to the data block pointed to by the corresponding first pointer; and
deleting the first snapshot.

6. The method of claim 1, further comprising:
receiving a request for a data block of a deleted snapshot of the dataset;
determining an oldest existing snapshot of the dataset generated after the deleted snapshot as a fourth snapshot; and
referencing pointers in the fourth snapshot that point directly to the data block of the deleted snapshot.

7. The method of claim 1, further comprising:
moving data from a source data block of the first data blocks to a destination data block; and
updating the first pointer corresponding to the source data block to point to the destination data block.

8. A system for snapshot indirection comprising:
a processor; and
a memory device that stores program code structured to cause the processor to:
store a first snapshot of a dataset, the first snapshot comprising a plurality of first pointers that each point to a corresponding first data block of a plurality of first data blocks associated with the first snapshot;
store, as second data blocks, data blocks created after a latest existing snapshot and modifications to the first data blocks modified after the latest existing snapshot;
generate a plurality of second pointers that each point to a corresponding second data block of the second data blocks; and
maintain, in a current record, the second pointers and references to the first snapshot for unmodified first data blocks.

9. The system of claim 8, wherein the program code is further structured to cause the processor to:
receive a snapshot capture request to capture a snapshot of the dataset;
create a second snapshot of the dataset by storing the current record as the second snapshot; and
update the current record by replacing the second pointers in the current record with references to the second snapshot.

10. The system of claim 9, wherein the program code is further structured to cause the processor to:
receive a read request for the second snapshot;
read second data blocks by following the second pointers;
read unmodified first data blocks by referencing the first snapshot; and
return the second data blocks and the unmodified first data blocks.

11. The system of claim 8, wherein to reference unmodified first data blocks by referencing the first snapshot, the program code is further structured to cause the processor to:
reference first pointers in the first snapshot that point directly to the unmodified first data blocks.

12. The system of claim 8, wherein the program code is further structured to cause the processor to:
receive a request to delete the first snapshot;
determine a third snapshot of the dataset generated after the first snapshot;
determine a reference in the third snapshot to a corresponding first pointer in the first snapshot;
replace the determined reference in the third snapshot with a pointer to the data block pointed to by the corresponding first pointer; and
delete the first snapshot.

13. The system of claim 8, wherein the program code is further structured to cause the processor to:
receive a request for a data block of a deleted snapshot of the dataset;
determine an oldest existing snapshot of the dataset generated after the deleted snapshot as a fourth snapshot; and
reference pointers in the fourth snapshot that point directly to the data block of the deleted snapshot.

14. The system of claim 8, wherein the program code is further structured to cause the processor to:
move data from a source data block of the first data blocks to a destination data block; and
update the first pointer corresponding to the source data block to point to the destination data block.

15. A computer-readable storage medium comprising computer-executable instructions, that when executed by a processor, cause the processor to:
store a first snapshot of a dataset, the first snapshot comprising a plurality of first pointers that each point to a corresponding first data block of a plurality of first data blocks associated with the first snapshot;
store, as second data blocks, data blocks created after a latest existing snapshot and modifications to the first data blocks modified after the latest existing snapshot;
generate a plurality of second pointers that each point to a corresponding second data block of the second data blocks; and
maintain, in a current record, the second pointers and references to the first snapshot for unmodified first data blocks.

16. The computer-readable storage medium of claim 15, wherein the computer-executable instructions, when executed by the processor, further cause the processor to:
receive a snapshot capture request to capture a snapshot of the dataset;
create a second snapshot of the dataset by storing the current record as the second snapshot; and
update the current record by replacing the second pointers in the current record with references to the second snapshot.

17. The computer-readable storage medium of claim 16, wherein the computer-executable instructions, when executed by the processor, further cause the processor to:
receive a read request for the second snapshot;
read second data blocks by following the second pointers;
read unmodified first data blocks by referencing the first snapshot; and
return the second data blocks and the unmodified first data blocks.

18. The computer-readable storage medium of claim 15, wherein to reference unmodified first data blocks by referencing the first snapshot, the computer-executable instructions, when executed by the processor, further cause the processor to:
reference first pointers in the first snapshot that point directly to the unmodified first data blocks.

19. The computer-readable storage medium of claim 15, wherein the computer-executable instructions, when executed by the processor, further cause the processor to:
receive a request to delete the first snapshot;
determine a third snapshot of the dataset generated after the first snapshot;
determine a reference in the third snapshot to a corresponding first pointer in the first snapshot;
replace the determined reference in the third snapshot with a pointer to the data block pointed to by the corresponding first pointer; and
delete the first snapshot.

20. The computer-readable storage medium of claim 15, wherein the computer-executable instructions, when executed by the processor, further cause the processor to:
receive a request for a data block of a deleted snapshot of the dataset;
determine an oldest existing snapshot of the dataset generated after the deleted snapshot as a fourth snapshot; and
reference pointers in the fourth snapshot that point directly to the unmodified first data blocks.
